(19) United States
(12) Patent Application Publication
(10) Pub. No.: US 2012/0045310 A1
(43) Pub. Date: Feb. 23, 2012

(54) Bale Destacker

(76) Inventor: Gary L. Kelderman, Oskaloosa, IA (US)

(21) Appl. No.: 12/859,901

(22) Filed: Aug. 20, 2010

(51) Int. Cl. B65G 59/06; B66C 1/44; B65G 61/00

(52) U.S. Cl. 414/801; 294/86.4; 294/106

(57) ABSTRACT

Biomass may become an important source of combustible fuel in the future. For biomass, such as switchgrass, to be economically viable as a fuel, the processes required to take the plant material from a green, growing plant in the field to an energy dense package must be efficient. A bale destacker may be used to disassemble stacks of bales of biomass after the bales have been brought from the field and before the bales are used for fuel. The bale destacker disassembles a stack of bales with no manual labor. A conveyor is used to move bales, first in stacks, then in pairs to and from the bale destacker.

### BACKGROUND OF THE INVENTION

1. Field of the Invention

The present invention relates generally to industrial equipment. More particularly the present invention relates to a method and apparatus for efficiently unstacking square bales from a stack and conveying said square bales in small sets or individually.

2. Background Art

Biomass as a fuel source is gaining interest and use in the United States and elsewhere. Some biomass products, such as switchgrass, can be baled in the same manner as livestock forage to increase its energy density, reduce its volume, and make storage and handling more efficient.

One consideration in the utilization of biomass as a source of energy is its net energy available. The raising, harvesting, and transport of biomass products all require energy input. It is counterproductive to expend more purchased energy (especially from fossil fuels) than can be extracted from the biomass.

Biomass bales typically arrive at a power plant site via flatbed semi trailer. The bales are unloaded from the trailer, but they must still be transported to the boiler where they are to be burned.

For transporting bales of forage material (used for animal feed) a relatively short distance, the bales are often speared with any one of a variety of bale spears available for use with agricultural tractors, pickup trucks and even draft animals. Bales of biomass, however, are preferably made so dense as to resist spearing. Additionally, spearing is likely to break the twine binding the bale together.

Another method used for transporting bales for animal feed in small lots for relatively short distances is the use of a frame, usually mounted on a loader on an agricultural tractor. Pivotally attached to the frame is a plurality of claws. The frame is set on a layer of bales, usually small square bales, and the claws rotated into the bales, hence capturing the layer of bales to the frame. The frame and bales may then be lifted and transported using the loader, and deposited in an orderly fashion at their destination.

Still another way used to transport forage bales is by agricultural elevator. Such elevators comprise a frame and at least one web chain with paddles or fins that provide sufficient friction to cause a bale to move with the web chain. Elevators are often used to elevate bales into a hay mow or to the top of a hay stack. A very similar apparatus is used to convey bales along a substantially horizontal path and dump the bales to a predetermined location for stacking and storage.

These latter two methods have traditionally been limited to small square bales.

Because the above transport methods have weaknesses for the transport of biomass bales (due to their large dimensions and greater density), there is a need for a method and apparatus for quickly and efficiently transporting biomass bales at the power plant site—as well as distribution sites. There is an especial need, not addressed in forage bale technology, for a method and apparatus for disassembling biomass bales from a stack of bales.

### SUMMARY OF THE INVENTION

Bales of biomass are made using common agricultural balers just as livestock forages are baled. Preferably, the resulting bales are rectangular parallelepiped in shape, to be easily and stably stackable, and to be efficiently stored in conventional rectangular parallelepiped loads and buildings. Bale size is preferably that commonly referred to as a “large square bale.” These bales typically weigh over 700 pounds and are tied with baling twine. The dimensions of the bales vary to accommodate the wishes of those involved in baling, storing, or feeding the bales. The present invention is not limited to a particular bale size.

Bales may be collected in the field using a bale picking truck such as the one disclosed in U.S. patent application Ser. No. 12/824,540, to Kelderman, filed Jun. 28, 2010 which application is incorporated herein by reference in its entirety.

For the purposes of this document, including the claims, a bale is defined as a compacted mass of material, bound together with some kind of binding material in a roughly rectangular parallelepiped shape. A stack of bales is defined as a plurality of bales assembled with at least one bale supported entirely on top of at least one other bale. The term destacking is defined as a process, the result of which is a disassembled stack such that no bale is supported entirely by any other bale.

An object of this invention is to provide a method and apparatus for disassembling a stack of bales with no manual labor.

The novel features which are believed to be characteristic of this invention, both as to its organization and method operation together with further objectives and advantages thereto, will be better understood from the following description considered in connection with accompanying drawings in which a presently preferred embodiment of the invention is illustrated by way of example. It is to be expressly understood however, that the drawings are for the purpose of illustration and description only and not intended as a definition of the limits of the invention.

### BRIEF DESCRIPTION OF THE DRAWINGS

FIG. 1 is a perspective view of a bale destacker of the present invention;

FIG. 2 is a top plan view of the bale destacker;

FIG. 3 is a side elevation view of the bale destacker;

FIG. 4 is an end elevation view of the bale destacker;

FIG. 5a is a first side elevation view of the bale destacker in operation;

FIG. 5b is a first perspective view of the bale destacker in operation;

FIG. 6a is a second side elevation view of the bale destacker in operation;

FIG. 6b is a second perspective view of the bale destacker in operation;

FIG. 7a is a third side elevation view of the bale destacker in operation;

FIG. 7b is a third perspective view of the bale destacker in operation;

FIG. 8a is a fourth side elevation view of the bale destacker in operation;

FIG. 8b is a fourth perspective view of the bale destacker in operation;

FIG. 9a is a fifth side elevation view of the bale destacker in operation;

FIG. 9b is a fifth perspective view of the bale destacker in operation;

FIG. 10a is a sixth side elevation view of the bale destacker in operation;

FIG. 10b is a sixth perspective view of the bale destacker in operation;

FIG. 11a is a seventh side elevation view of the bale destacker in operation;

FIG. 11b is a seventh perspective view of the bale destacker in operation;

FIG. 12a is a eighth side elevation view of the bale destacker in operation;

FIG. 12b is a eighth perspective view of the bale destacker in operation;

FIG. 13a is a ninth side elevation view of the bale destacker in operation;

FIG. 13b is a ninth perspective view of the bale destacker in operation;

FIG. 14a is a tenth side elevation view of the bale destacker in operation;

FIG. 14b is a tenth perspective view of the bale destacker in operation;

FIG. 15a is a eleventh side elevation view of the bale destacker in operation;

FIG. 15b is a eleventh perspective view of the bale destacker in operation;

FIG. 16a is a twelfth side elevation view of the bale destacker in operation;

FIG. 16b is a twelfth perspective view of the bale destacker in operation;

FIG. 17a is a thirteenth side elevation view of the bale destacker in operation;

FIG. 17b is a thirteenth perspective view of the bale destacker in operation;

FIG. 18 is a perspective view of a standard assembly for the destacker;

FIG. 19 is a perspective view of an inner sleeve of the standard assembly;

FIG. 20 is two side elevation views of the standard assembly;

FIG. 21 is a side elevation view showing squeeze arms of the destacker in a contracted mode;

FIG. 22 is a is a side elevation view showing squeeze arms of the destacker in an expanded mode; and

FIG. 23 shows both contracted and expanded modes of the squeeze arms.

### BEST MODE FOR CARRYING OUT THE INVENTION

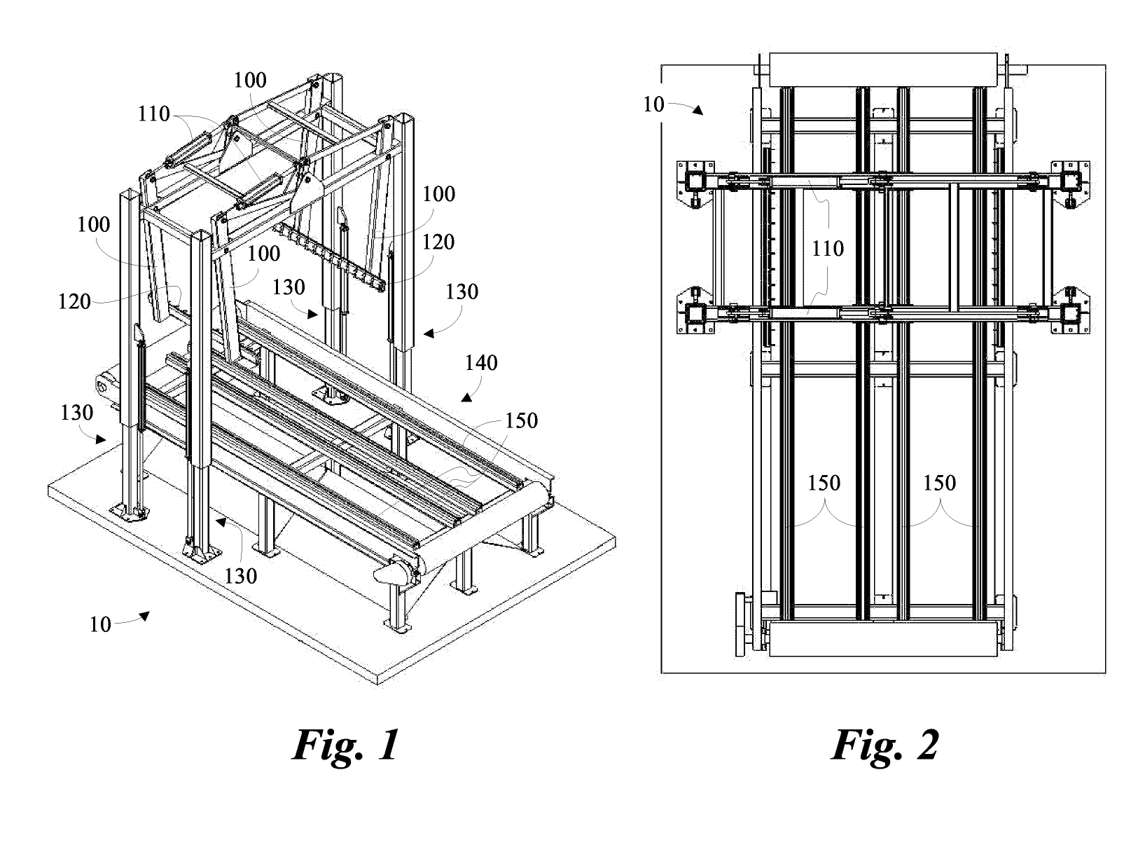

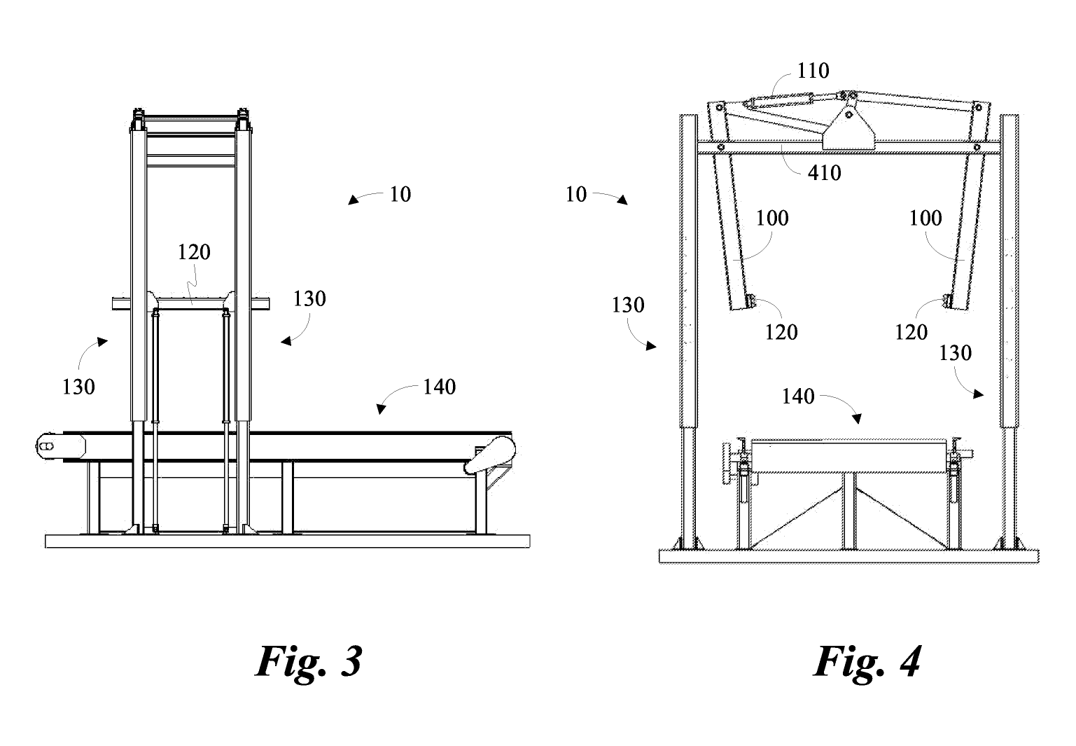

Referring now to the drawings wherein like reference numerals indicate identical or corresponding parts throughout the several views, the bale destacker 10 of the present invention in its preferred embodiment is illustrated in FIGS. 1-17b and comprises squeeze arms 100 manipulated by a pair of squeeze arm actuators 110, which may be stroked hydraulically, pneumatically, magnetically, electrically, etc. Each pair of squeeze arms 100 on one side of the destacker 10 is connected by a toothed cross member 120 to better grip bales 510 of biomass. The squeeze arms 100 are operatively, pivotally attached to a support beam 410.

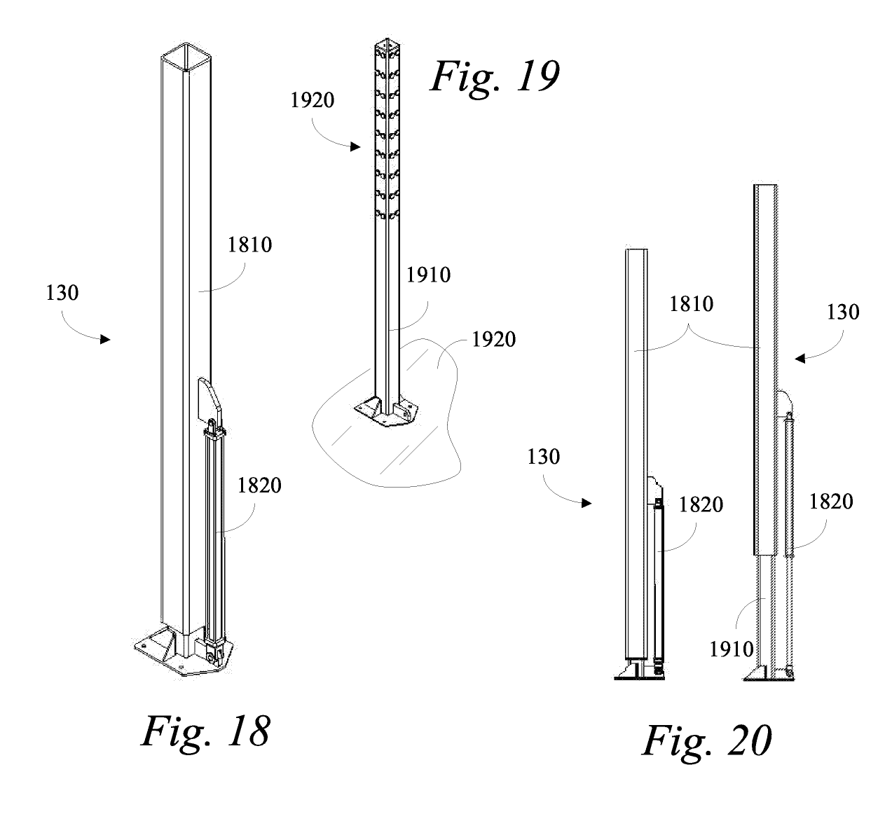

The upper assembly of the bale destacker 10 is supported by four standard assemblies 130, details of which may be discerned in FIGS. 18-20. Each standard assembly 130 comprises an outer sleeve 1810, an inner beam 1910, and a standard actuator 1820 which may be stroked mechanically, hydraulically, pneumatically, magnetically, electrically, etc. The inner beam 1910 preferably comprises a plurality of hard plastic, or other polymer, bearings 1920 on which rides the outer sleeve 1810 as the standard actuator 1820 raises and lowers the outer sleeve 1810 relative to the inner beam 1910, as depicted in FIG. 20. The inner beam is preferably rigidly attached to concrete, asphalt, or other ground surface material 1920.

The bales 510 are moved within the vicinity of the bale destacker 10 by a destacker conveyor 140, comprising a plurality of drag chains 150, although belts, cables, or wheeled dollies may also serve the purpose.

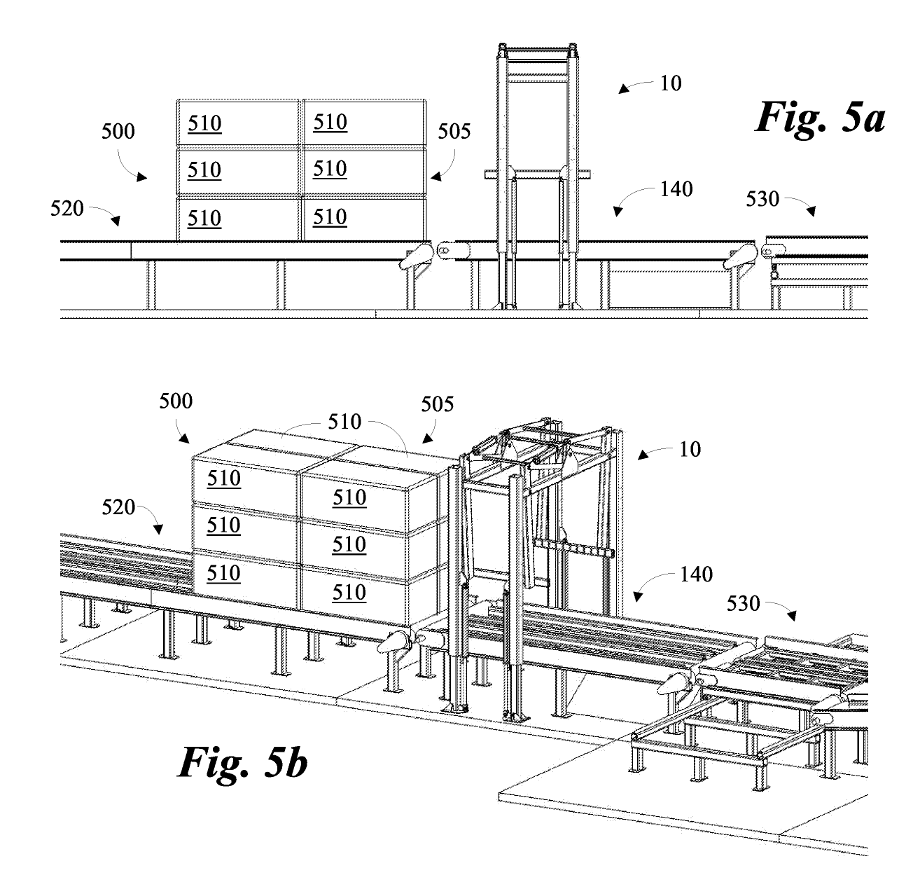

FIGS. 5a-17b depict the process two stacks 500, 505 of individual bales 510 undergo as the stacks 500, 505 are destacked by the destacker 10. In FIGS. 5a and 5b, the stacks 500, 505 of bales 510 approach the destacker 10, in these illustrations, from the left. The stacks 500 are conveyed by a conveyor system 520, 140, 530, including a stack conveyor 520, the destacker conveyor 140, and a bale conveyor 530. The extent and configuration of the conveyor system 520, 140, 530 is dependent on the nature of the destacking site—the topography, distance from the unloading dock to the boiler, etc.

Dimensions of the destacker 10 are such that each stack 500, 505 may pass between the standard assemblies 130 and under the support beam 410.

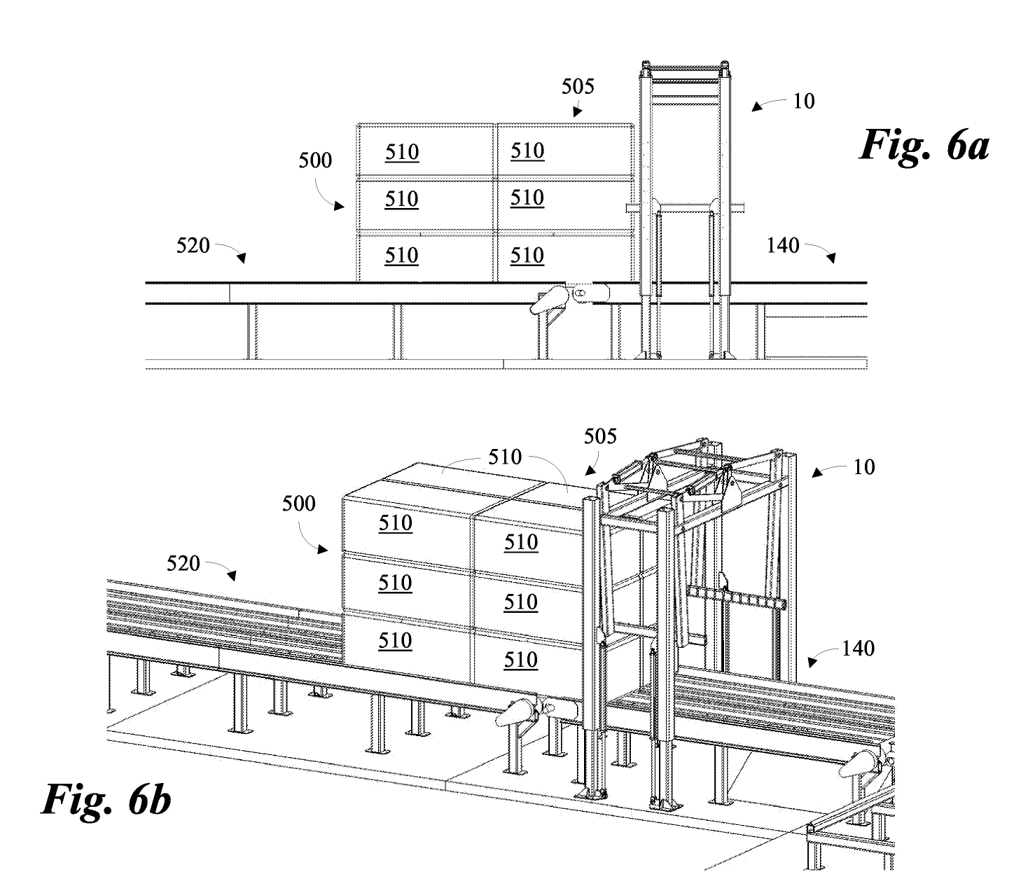

FIGS. 6a and 6b illustrate a front bale stack 505 passing from the stack conveyor 520 to the destacker conveyor 140.

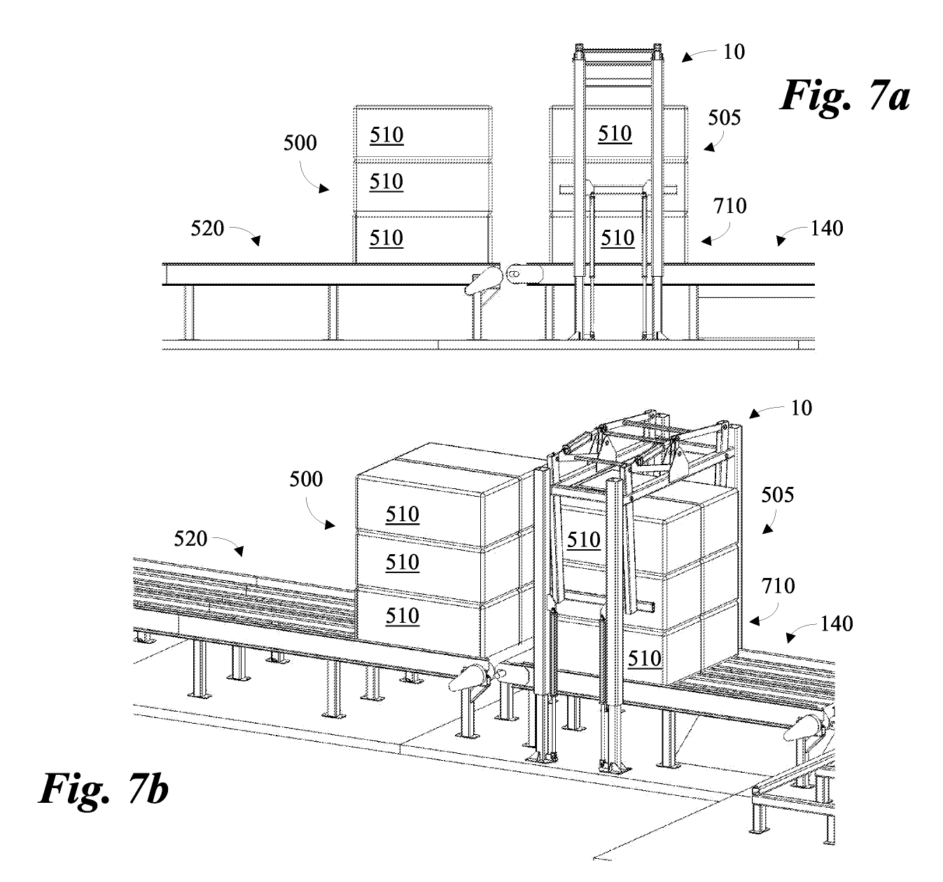

In FIGS. 7a and 7b, independent operation of the stack conveyor 520 and the destacker conveyor 140 is shown. Here the front bale stack 505 is separated from the rear bale stack 500 due to this independent operation. Because of the separation, the individual bales 510 between the two stacks 500, 505 do not contact one another, causing friction that can upset the rear stack 500 during destacking

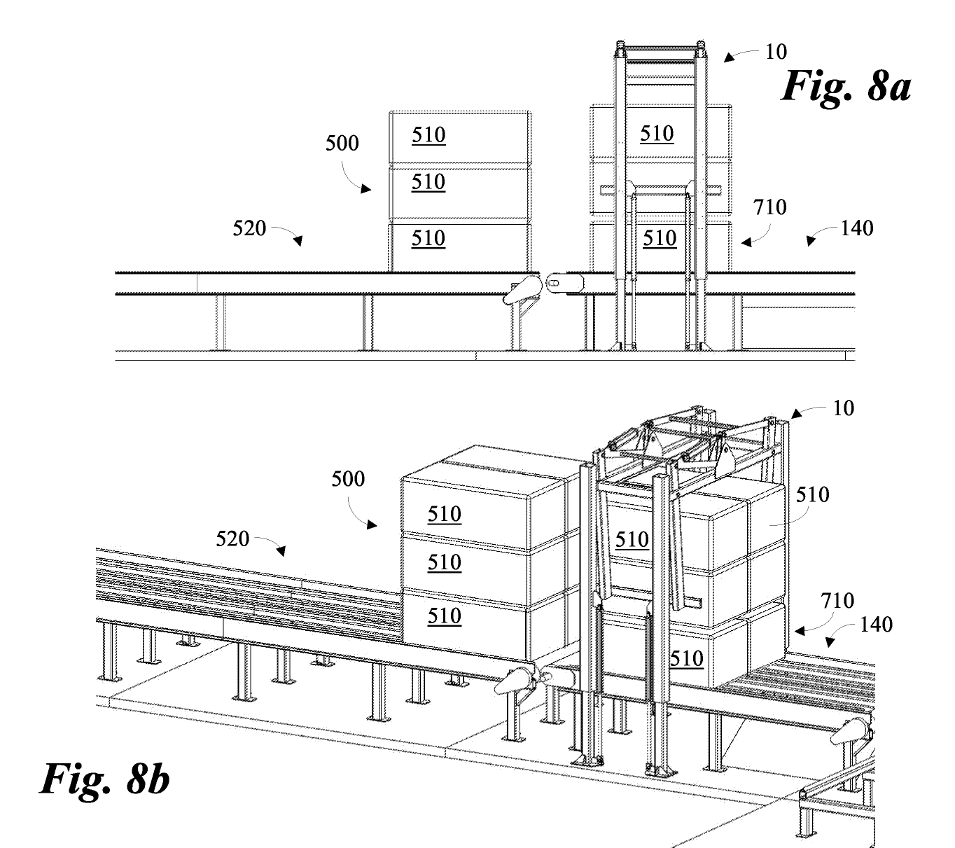

Having separated the two stacks 500, 505, the destacker can now begin destacking the front stack 505. To effect this destacking, the squeeze arm actuators 110 are actuated, thus drawing the lower ends of the squeeze arms 100 inward and engaging the toothed cross members 120 to the pair of bales 510 immediately on top of the bottommost bales 710. Then the standard actuators 1820 are actuated to raise all the bales 510 above the bottommost bales 710 as depicted in FIGS. 8a and 8b.

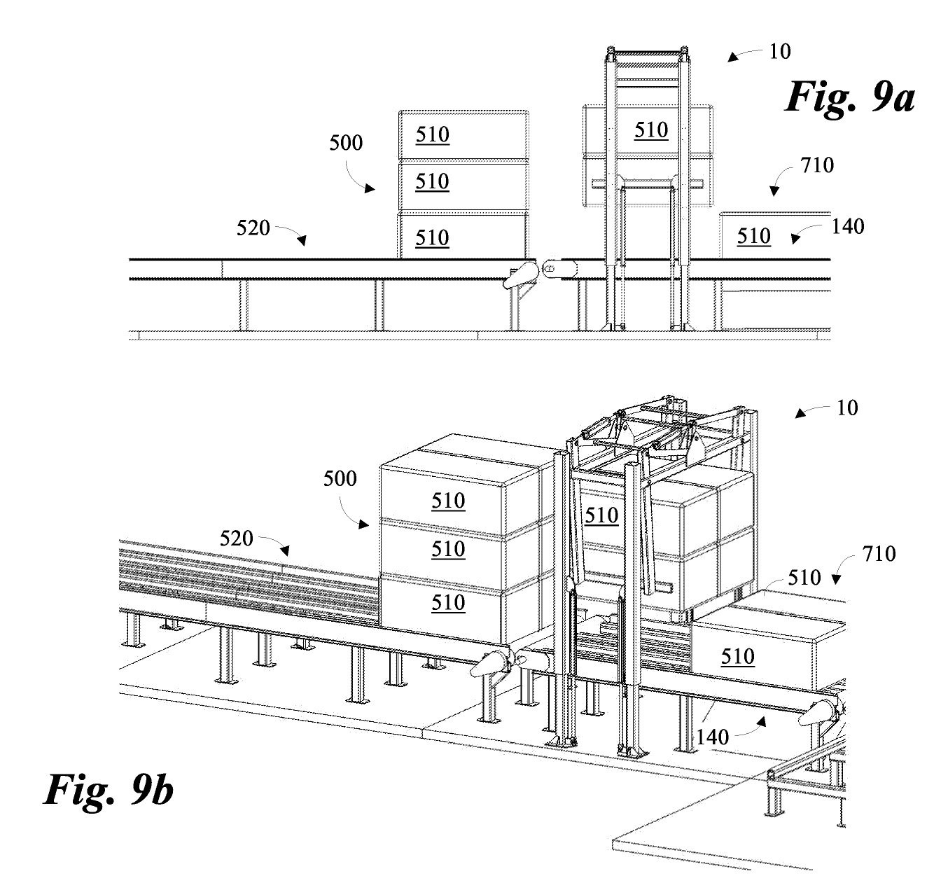

In FIGS. 9a and 9b, the independent operation of the destacker conveyor 140 relative to the stack conveyor 520 is again illustrated. This time, the bottommost pair of bales 710 is conveyed along the destacker conveyor 140 away from the destacker 10 while the remaining bales 510 remain engaged in the destacker 10. The rear stack 500 remains stationary on the stack conveyor 520. At this point, the bottommost pair of bales 710 has been destacked.

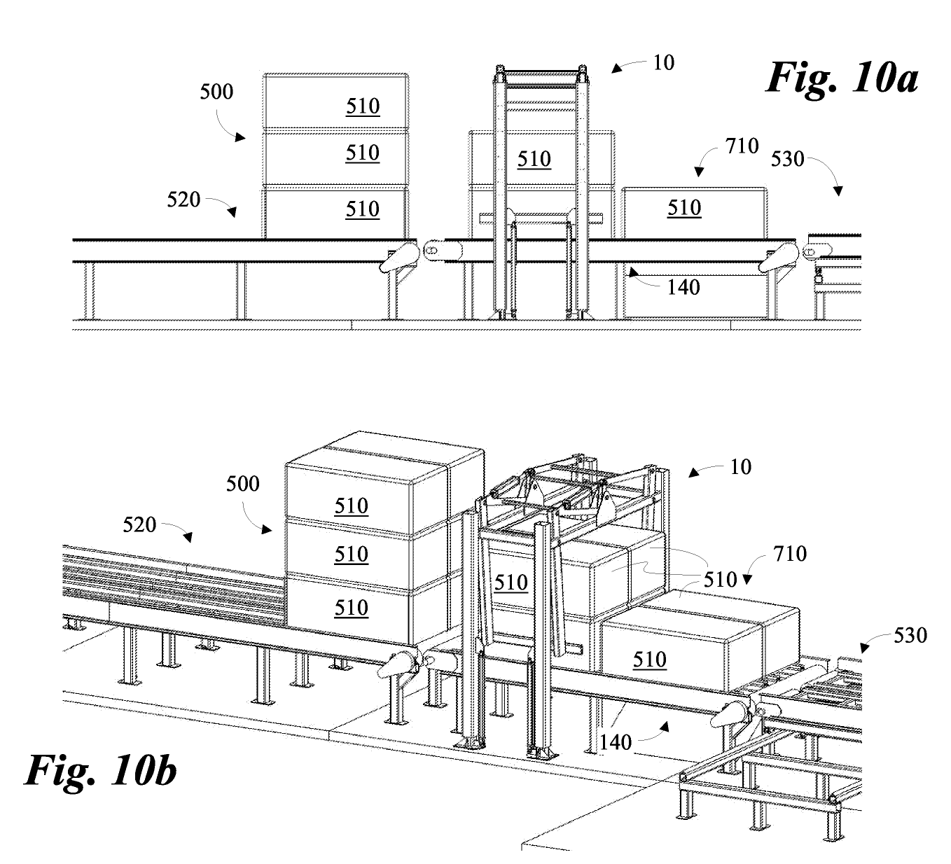

Note that, in FIGS. 8a-9b, the standard actuators 1820 are extended sufficiently that they may be contracted more than a height of a bale 510 as shown in FIGS. 10a and 10b. In these figures, the bales 510 that had been engaged in the destacker 10 are lowered to the destacker conveyor 140. There is preferably a space between the bales 510 in the destacker and the pair of bales 710 already destacked.

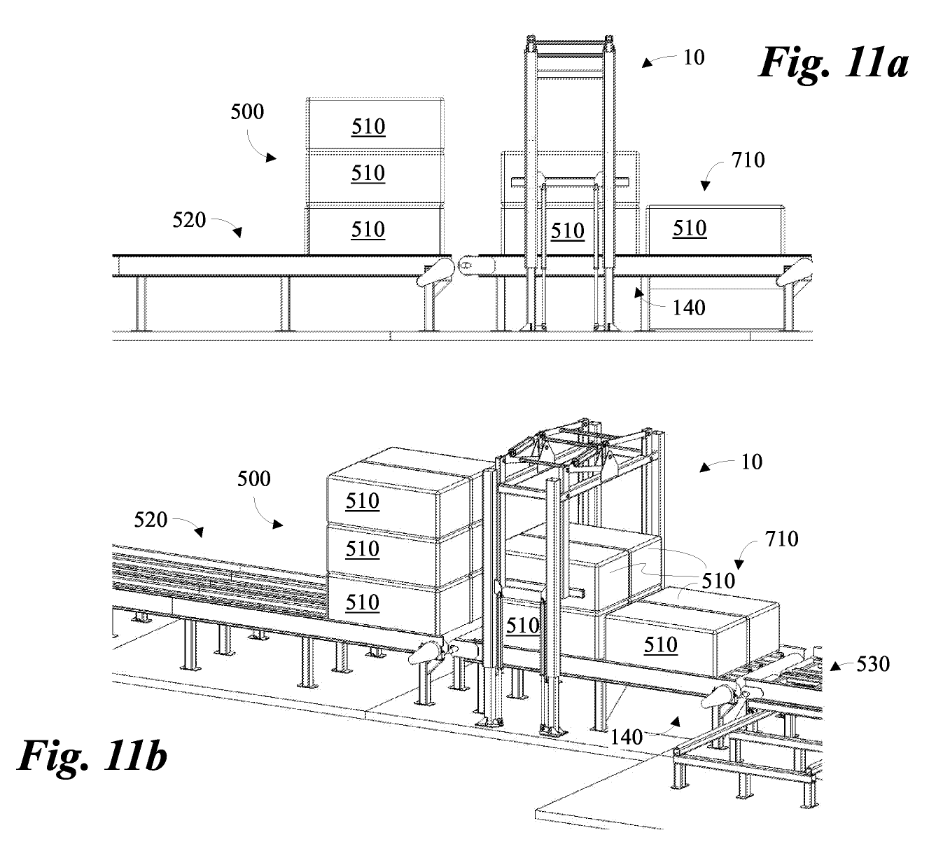

At this point, as illustrated in FIGS. 11a and 11b, the squeeze arm actuators 110 are contracted, thus drawing the lower ends of the squeeze arms 100 outward to disengage the bales 510 that, up to now, had been engaged in the squeeze arms 100. The standard actuators 1820 are again actuated, this time they are expanded approximately the height of a bale 510. Once the standard actuators 1820 are expanded, the squeeze arm actuators 110 are expanded, thus drawing the lower ends of the squeeze arms 100 inward and engaging the toothed cross members 120 to the pair of bales 510 immediately on top of the new bottommost bales 510.

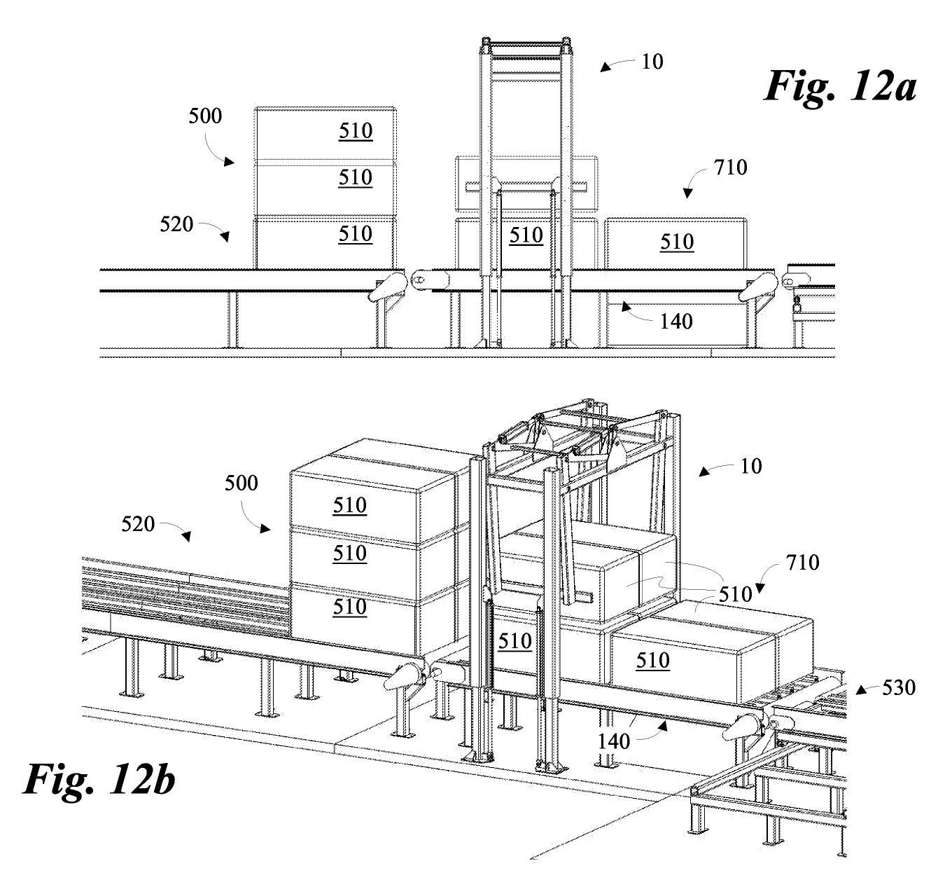

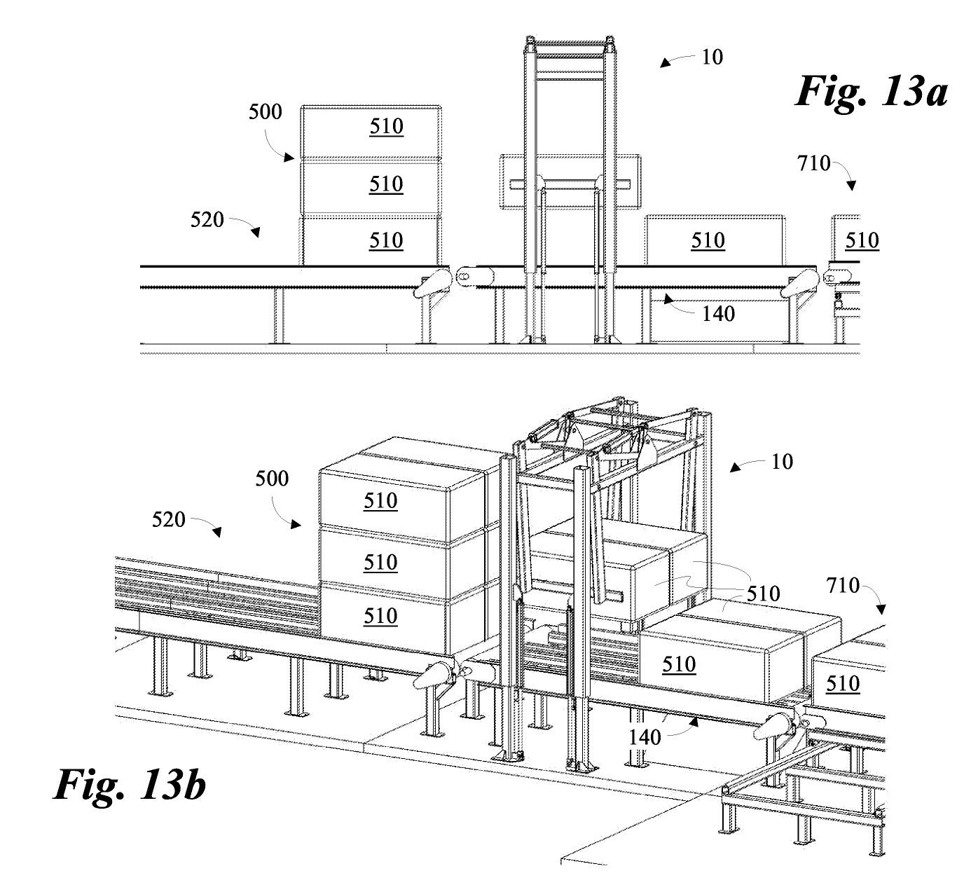

In FIGS. 12a and 12b, the bales 510 engaged by the toothed cross member 120 are lifted by a further expansion of the standard actuators 1820 sufficiently to clear the bottommost bales 510, which are conveyed away from the destacker 10 in FIGS. 13a and 13b. The previously destacked bales 710 must be conveyed in the same direction at least as far—somewhat more than a length of a bale 510.

The front most bales 710 in the system are now on the bale conveyor 530, which preferably operates independently of the destacker conveyor 140.

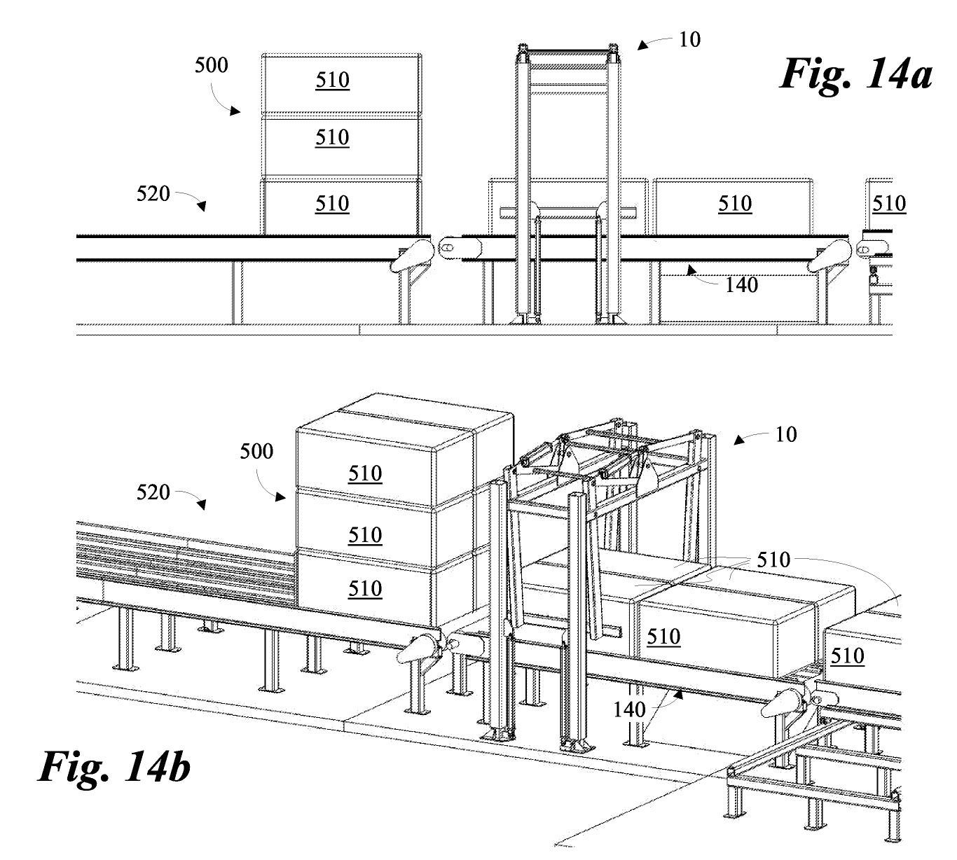

In FIGS. 14a and 14b, the bales 510 that had been engaged in the destacker 10 are lowered to the destacker conveyor 140 by the contraction of the standard actuators 1820. There is preferably a space between the bales 510 in the destacker and the pair of bales 510 already destacked.

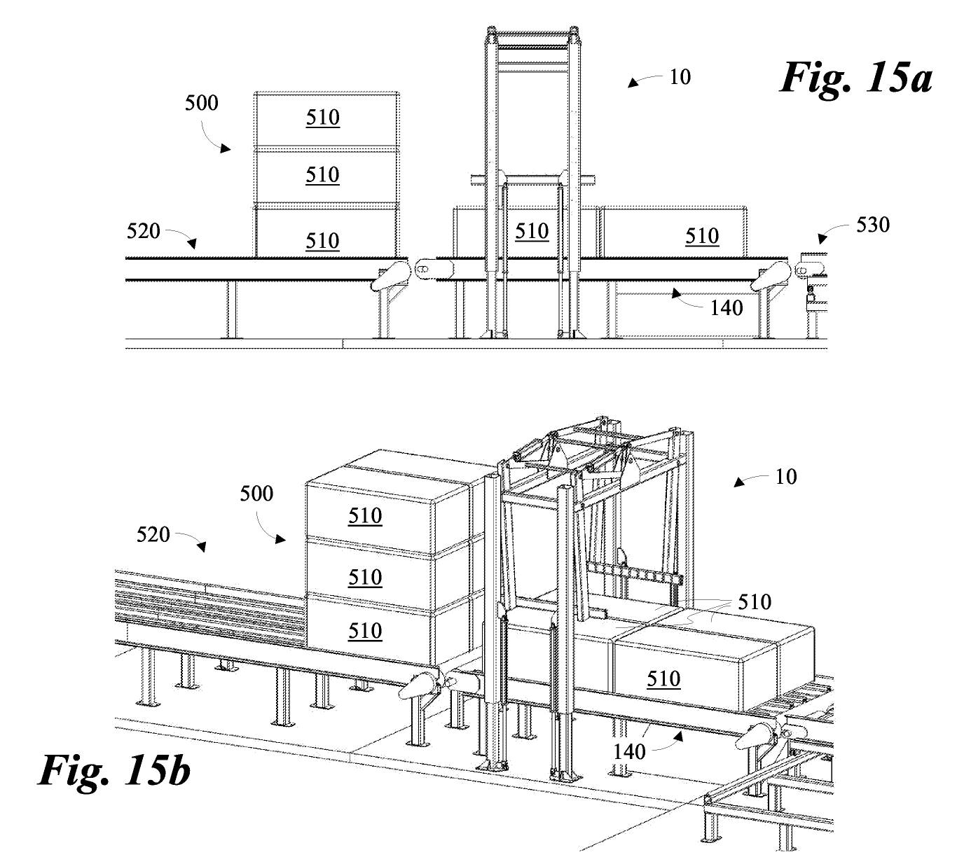

At this point, as illustrated in FIGS. 15a and 15b, the squeeze arm actuators 110 are contracted, thus drawing the lower ends of the squeeze arms 100 outward to disengage the bales 510 that, up to now, had been engaged in the squeeze arms 100.

The standard actuators 1820 are again expanded approximately the height of a bale 510.

At this time, the entire bale stack 505 has been destacked. No bale 510, formerly a component of the stack 505, is supported on any other bale 510. The pairs of individual bales 510 may now be conveyed independently of additional destacking operations, or the conveying may be a function of these additional destacking operations.

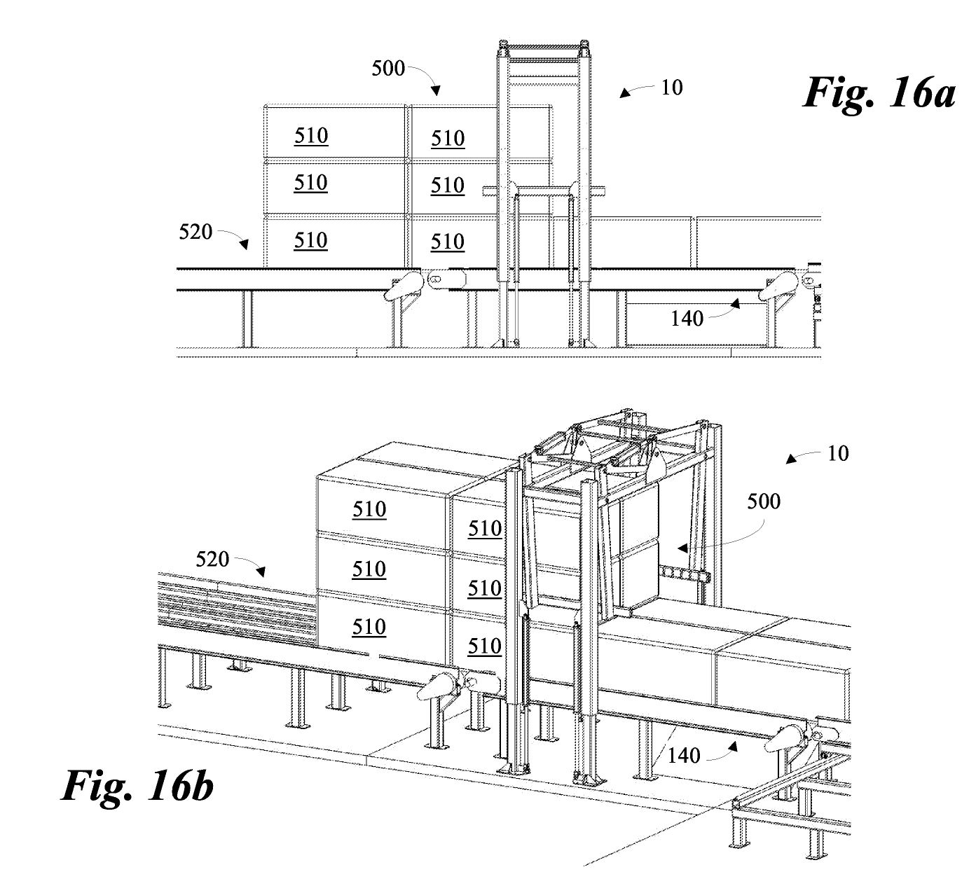

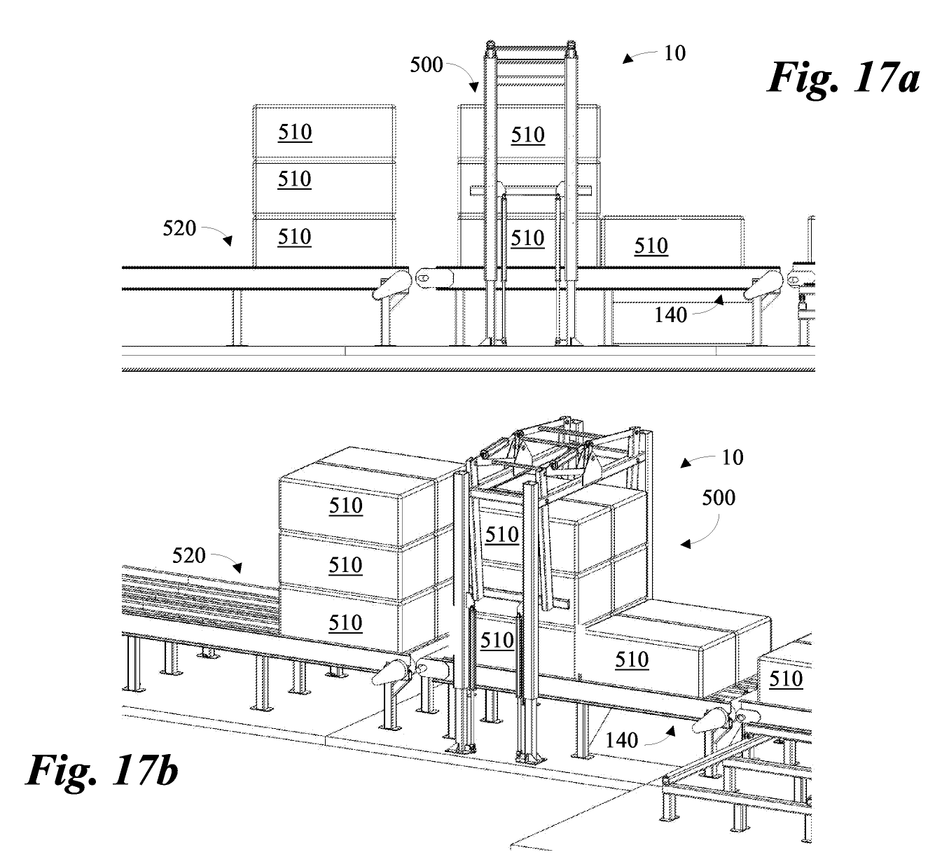

In FIGS. 16a-17b, a new stack 500 replaces the now destacked stack 505 in the destacker 10 and the process described above is repeated.

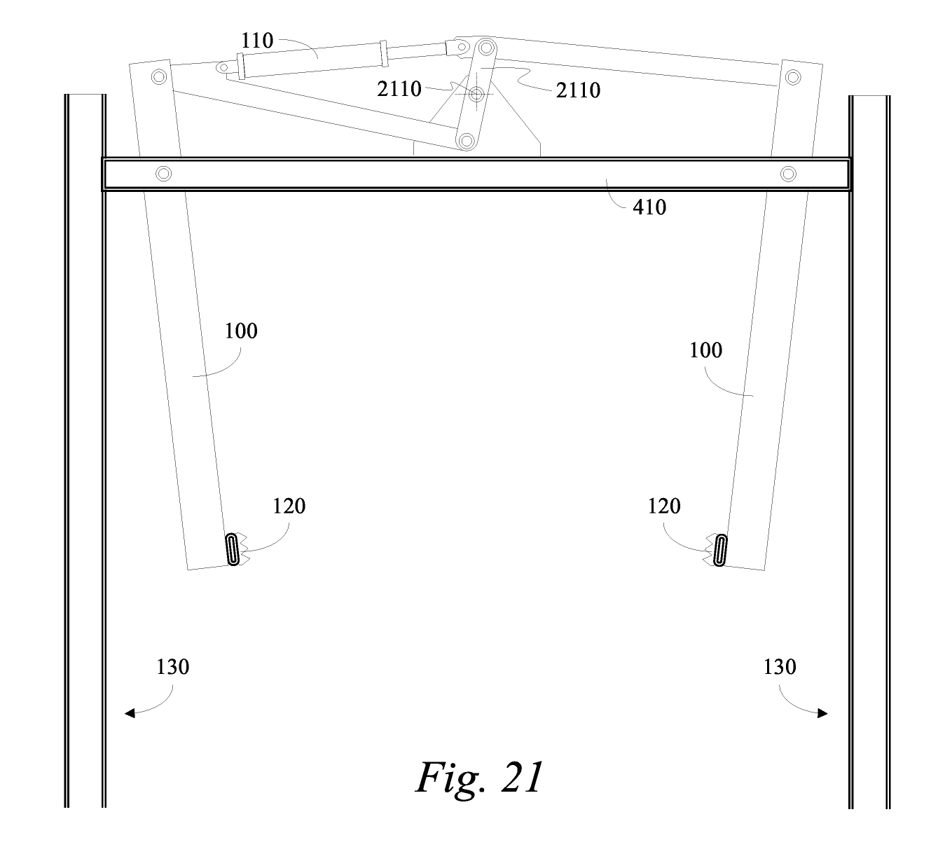

Details of the assembly that allows the gripping of the bales 510 are shown in FIGS. 21-23. FIG. 21 shows the squeeze arms 100 in their inward or gripping position by virtue of the extended squeeze arm actuators 110 (only one shown in FIGS. 21-23). In this position, bales 510 would be gripped for lifting and subsequent lowering.

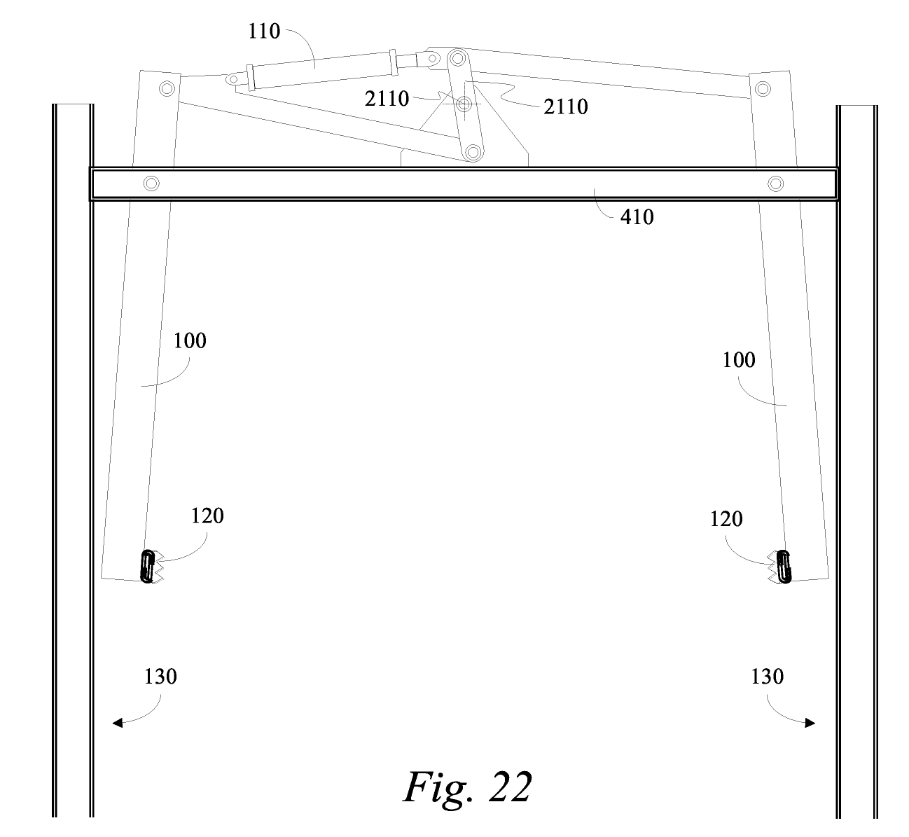

In FIG. 22, the squeeze arms 100 are shown in their outward orientation. To effect this squeeze arm position, the squeeze arm actuators 110 are contracted. In this position, the toothed cross members 120 are clear of bales 510, hence the destacker assembly may be raised or lowered to put the toothed cross members 120 in an appropriate position for disposal against the bale 510, or the stacks 500, 505 or bales 510 may be moved into or out of position by the destacker conveyor 140.

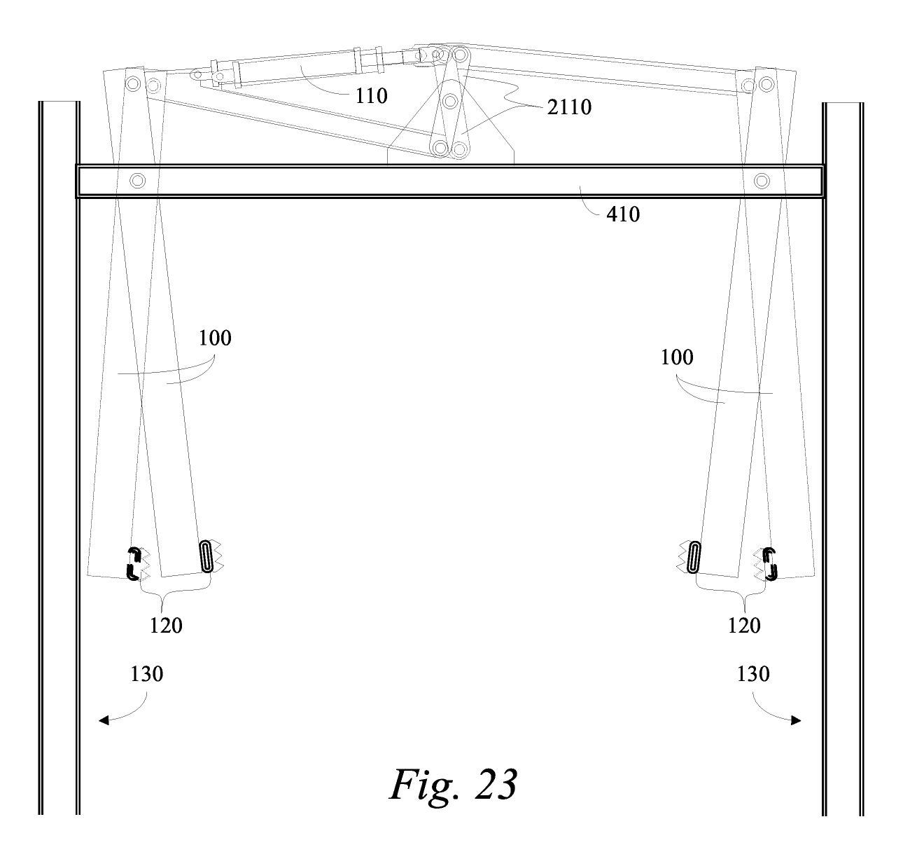

In FIG. 23, the squeeze arms 100 are shown in both the above positions for clarity and contrast. The squeeze arms 100 in their outward position are shown in phantom lines, and the other components of the assembly are also shown in phantom lines for this position. The components in solid lines correspond to the squeeze arms 100 in their inward position.

The bales 510 and the stacks 500, 505 may not be perfectly centered between the toothed cross members 120 at any point in the process outlined above. Equalizers 2110 (only one shown in FIGS. 21-23) provide flexibility in the location of the bales 510 or stack 500, 505. Because the equalizers 2110 are free to rotate about a center axis of pivot 2120, irrespective of the position of the squeeze arm actuators 110, the squeeze arms 100 may both be biased to one side or the other. Hence, bales 510 and the stacks 500, 505 that are not centered between the squeeze arms 100 may be accommodated without operator involvement.

The use of the bale destacker 10 described herein is not limited to use with bales 510 of biomass for fuel. Bales 510 to be used for livestock feed and bales 510 to be used for erosion control are examples of uses to which the bale destacker 10 may be applied. The present invention is not limited to bales 510 of a particular size or use.

It should be noted that many modifications and variations of the present invention are possible in light of the above teachings. It is, therefore, to be understood that within the scope of the appended claims, the invention may be practiced otherwise than as specifically described.

I claim:

1. A method of disassembling a stack of bales, the method comprising:
(a) conveying the stack of bales between a plurality of squeeze arms;
(b) gripping at least one bale with said plurality of squeeze arms, the at least one bale being supported by at least one lower bale;
(c) elevating the at least one bale between the plurality of squeeze arms above the at least one lower bale; and
(d) conveying the at least one lower bale away from the plurality of squeeze arms.

2. The method of claim 1 wherein elevating the at least one bale between the plurality of squeeze arms above the at least one lower bale comprises elevating the squeeze arms relative to the at least one lower bale.

3. The method of claim 1 additionally comprising:
(a) lowering the at least one bale after the at least one lower bale has been conveyed away from the plurality of squeeze arms;
(b) releasing the plurality of squeeze arms from the at least one bale; and
(c) conveying the at least one bale away from the plurality of squeeze arms.

4. The method of claim 1 wherein gripping the at least one bale with said plurality of squeeze arms comprises:
(a) disposing a first squeeze arm on a first side of the at least one bale;
(b) disposing a second squeeze arm on a second side of the at least one bale;
(c) operatively pivotally attaching a first linkage arm to the first squeeze arm;
(d) operatively pivotally attaching a second linkage arm to the second squeeze arm;
(e) operatively pivotally attaching an actuator to the first and second linkage arms;
(f) actuating the actuator;
(g) causing, by virtue of the actuating of the actuator, the first squeeze arm to approach the first side of the at least one bale; and
(h) causing, by virtue of the actuating of the actuator, the second squeeze arm to approach the second side of the at least one bale.

5. The method of claim 1 wherein elevating the at least one bale between the plurality of squeeze arms above the at least one lower bale comprises:
(a) operatively supporting an assembly comprising the squeeze arms with at least one standard;
(b) operatively attaching an actuator to the at least one standard;
(c) raising the at least one standard by actuating the actuator; and
(d) elevating the assembly comprising the squeeze arms by virtue of raising the at least one standard.

6. The method of claim 1 wherein conveying the at least one lower bale away from the plurality of squeeze arms comprises:
(a) disposing the at least one lower bale on a conveyor; and
(b) conveying the at least one lower bale with the conveyor.

7. The method of claim 5 wherein the at least one standard comprises an outer sleeve and an inner beam, the method additionally comprising:
(a) slidably disposing the inner beam inside the outer sleeve;
(b) rigidly attaching the inner beam to a ground surface material;
(c) operatively attaching a first end of the actuator to the outer sleeve; and
(d) operatively attaching a second end of the actuator to the inner beam.

8. The method of claim 4 additionally comprising:
(a) operatively, pivotally connecting the first linkage arm to a first end of an evener;
(b) operatively, pivotally connecting the second linkage arm to a second end of the evener;
(c) operatively, pivotally connecting the evener to a frame at a pivot axis; and
(d) permitting the evener to pivot on the pivot axis to even forces by the first and second squeeze arms on the at least one bale.

9. The method of claim 1 additionally comprising:
(a) conveying the stack of bales to a destacker conveyor on a stack conveyor;
(b) conveying the stack of bales between the plurality of squeeze arms with the destacker conveyor, said destacker conveyor operating independently of the stack conveyor; and
(c) conveying the at least one lower bale away from the plurality of squeeze arms on the destacker conveyor.

10. The method of claim 9 additionally comprising conveying the at least one lower bale away from the plurality of squeeze arms on the destacker conveyor to a bale conveyor, said bale conveyor operating independently of the destacker conveyor and the stack conveyor.

11. An apparatus for destacking a stack of bales, the apparatus comprising:
(a) a first squeeze arm disposed on a first side of the stack of bales;
(b) a second squeeze arm disposed on a second side of the stack of bales;
(c) a linkage assembly by which the first and second squeeze arms are manipulated to apply pressure on the first and second sides of the stack of bales; and
(d) at least one standard to support components of the apparatus comprising the first and second squeeze arms and the linkage assembly.

12. The apparatus of claim 11 additionally comprising a conveyor to convey the stack of bales.

13. The apparatus of claim 11 wherein the first squeeze arm and the second squeeze arm each comprise:
(a) a toothed cross member to engage to a bale within the stack of bales;
(b) a first pivot axis on which to pivot relative to a frame; and
(c) a second pivot axis on which to pivot relative to a linkage arm.

14. The apparatus of claim 11 wherein the linkage assembly comprises:
(a) a first linkage arm, operatively, pivotally connected to the first squeeze arm;
(b) a second linkage arm, operatively, pivotally connected to the second squeeze arm;
(c) an evener, operatively pivotally connected to the first linkage arm, the second linkage arm, and a frame; and
(d) an actuator operatively connected to the first and second linkage arms and by which the squeeze arms are manipulated.

15. The apparatus of claim 11 wherein the at least one standard comprises:
(a) an outer sleeve;
(b) an inner beam, disposed slidably inside the outer sleeve and rigidly, operatively attached to a ground surface material; and
(c) an actuator, operatively attached at a first end to the outer sleeve and operatively attached at a second end to the inner beam.
